(19) United States
(12) Patent Application Publication
(10) Pub. No.: US 2013/0200129 A1
(43) Pub. Date: Aug. 8, 2013

(54) APPARATUS FOR DRIVING AND REMOVING FASTENERS

(71) Applicant: Jeremy Paddock, Auburn, NY (US)

(72) Inventor: Jeremy Paddock, Auburn, NY (US)

(21) Appl. No.: 13/750,630

(22) Filed: Jan. 25, 2013

Related U.S. Application Data
(60) Provisional application No. 61/591,055, filed on Jan. 26, 2012.

(51) Int. Cl. B25C 5/10; B25C 11/00; B25C 5/06

(52) U.S. Cl. CPC B25C 5/10; B25C 5/06; B25C 11/00
USPC 227/63; 227/140; 227/146

(57) ABSTRACT

The present disclosure describes embodiments of a construction apparatus, or tool, that can drive and remove fasteners (e.g., staples). These embodiments have a handle portion, a head portion, and a fastener guide that orients the fastener in a ready-to-be deployed state. Actuation of the head portion can transmit a driving force to the fastener, thereby moving the fastener from the ready-to-be deployed state to a deployed state, which in one example drive the fastener into a target object (e.g., a board). The construction apparatus can also come equipped with a remover element that can transmit a removal force applied to the construction tool to the fastener. In one embodiment, the construction apparatus finds particular use with electrical staples, as the proposed designs can prevent damage to electrical cables, prevent the end user from striking his hand and fingers, and eliminate the need for carrying and/or using additional tools to mount and remove staples.

### CROSS-REFERENCE TO RELATED APPLICATIONS

This application claims the benefit of priority to U.S. Provisional Patent Application Ser. No. 61/591,055, filed on Jan. 26, 2012 and entitled “Apparatus for Driving Fasteners.” The content of this provisional application is incorporated by reference in its entirety herein.

### BACKGROUND

The present disclosure describes subject matter that relates to tools, hand tools, and trade tools, and in several embodiments to a construction apparatus that can retain and drive a fastener by axially transferring a driving force from one end to another end where the fastener is secured.

Multi-purpose tools are known to provide robust devices that offer solutions to day-to-day problems in a single, unitary structure. In the construction industry, tradesmen may favor such tools to reduce the number of separate tools they must carry to complete a task. The selection of tools can be particularly extensive for electricians and those involved in running electrical cables, telecommunication cables, and similar conductive devices in construction. These individuals must have tools to not only prepare and connect electrical wires together and to related fixtures, but also to attach and/or to affix the electrical cables to structures, e.g., to avoid entangling the separate wires and, more particularly, to hide the electrical wires from view and to allow for proper covering (e.g., drywall) to be installed during the construction process. For example, the installation of electrical cable in a structure often involves positioning the electrical cable on a rafter, joist, or stud and securing the electrical cable with a fastener to prevent the electrical cable from moving out of position.

Fasteners commonly used for securing electrical cable include U-shaped staples (also “staples”) that fit about the electrical cable. These staples are large (e.g., ½ in. and 1″) and require the electrician to use their hands to hold the staple and then a hammer or other striking implement to drive the staple, e.g., into the stud. The staple must be set tightly enough in the base and around the wires to hold the wires in place. However, using the hand to hold the staple is very dangerous, making the hand vulnerable to strikes from the hammer, and using a hammer may force the staple into the insulation on the wire or may strike the cabling or wiring, both of which can crush or damage the insulation or protective covering of the electrical cable. Such damage can expose the conductive wires inside of the electrical cable.

Potential hazards exist when electrical cables are not properly installed. Setting the staples incorrectly greatly increases the danger that the staple may contact the live conductive wires inside of the electrical cables. This scenario can cause an electric short or the live conductive wire can energize the staple with an electrical charge. A person that touches the staple could receive an electrical shock. Moreover, exposed conductive wiring and even binding the wires to tightly with the staple itself can create a short-circuit and increase the possibility of fire. In the communications industry, damaging the sheath of a coaxial cable with a staple is known to impair or render the coaxial cable totally useless.

Thus, to avoid these potentially hazardous conditions, electricians must take care to properly install the staples and other fasteners proximate electrical cables. Unfortunately, construction often dictates that the electrician install the staples in an inaccessible or difficult to reach location. For example, typical inaccessible locations are often found along the eaves of a home, in attics, or some other elevated position that is not readily accessible to people.

In the past it has been known to utilize an elongated staple-installing tool where staples are to be placed at the outer end of the tool and an electrical cord be placed between the legs of the staple and the staple located at the desired position ready for installation. Installation is caused by hammering at the base of the tool which will cause the staple to be installed and the electrical cord held at this location. However, although effective in its operation, this procedure requires the electrician to carry a multiplicity of tools and, more importantly, still may not properly set the staples in position to substantially avoid damage. Moreover, it is common that staples are removed after a short period of time. For the removing the staple the elongated tool often cannot assist. Therefore, yet another tool may be required.

### SUMMARY

This disclosure describes embodiments of a robust, multi-purpose tool that allows an end user (e.g., an electrician) to quickly and easily set and drive fasteners without the need to use another tool or to use both hands. These embodiments offer these useful features in combination with components that allow the end use to also remove and/or reposition fasteners using the same tool. For electrical applications, these tools are particularly useful to set electrical staples and related fasteners because the tool can control the depth at which the fasteners are secured into the material (e.g., wood). This feature prevents the staples from being driven too deeply, which can cause the staple to penetrate and/or damage the protective covering of electrical wires exposing the conductive material (e.g., copper) inside. Breaching the protective coating can result in arcing between the copper and the staple and/or between adjacent electrical wires.

### BRIEF DESCRIPTION OF THE DRAWINGS

Reference is now made briefly to the accompanying Appendix in which:

FIG. 1 depicts a schematic diagram of an exemplary embodiment of a construction apparatus;

FIG. 2 depicts a perspective view of an exemplary embodiment of a construction apparatus;

FIG. 3 depicts a side, exploded assembly view of the construction apparatus of FIG. 2;

FIG. 4 depicts a side, cross-section, assembled view of the construction apparatus of FIG. 3;

FIG. 5 depicts a detail view of FIG. 4 that illustrates one configuration of the shaft in a ready-to-be actuated position;

FIG. 6 depicts a detail view of FIG. 4 that illustrates one configuration of the shaft in an actuated position;

FIG. 7 depicts a side, cross-section view of a tubular element for use in a construction apparatus, e.g., the construction apparatus of FIGS. 1, 2, 3, 4, 5, and 6;

FIG. 8 depicts an end view of the tubular element of FIG. 7;

FIG. 9 depicts a side, cross-section view of an end cap element for use in a construction apparatus, e.g., the construction apparatus of FIGS. 1, 2, 3, 4, 5, and 6;

FIG. 10 depicts a front view of the end cap element of FIG. 8;

FIG. 11 depicts a back view of the end cap element of FIG. 8;

FIG. 12 depicts a side, cross-section view of a base component for use in a construction apparatus, e.g., the construction apparatus of FIGS. 1, 2, 3, 4, 5, and 6;

FIG. 13 depicts a bottom view of the base component of FIG. 12

FIG. 14 depicts a front view of the base component of FIG. 12;

FIG. 15 depicts a side view of a fastener remover element for use in a construction apparatus, e.g., the construction apparatus of FIGS. 1, 2, 3, 4, 5, and 6;

FIG. 16 depicts a back view of the fastener remover element of FIG. 15;

FIG. 17 depicts a bottom view of the fastener remover element of FIG. 16; and

FIG. 18 depicts a perspective view of a bushing for use in a construction apparatus, e.g., the construction apparatus of FIGS. 1, 2, 3, 4, 5, and 6.

Where applicable like reference characters designate identical or corresponding components and units throughout the several views, which are not to scale unless otherwise indicated.

### DETAILED DISCUSSION

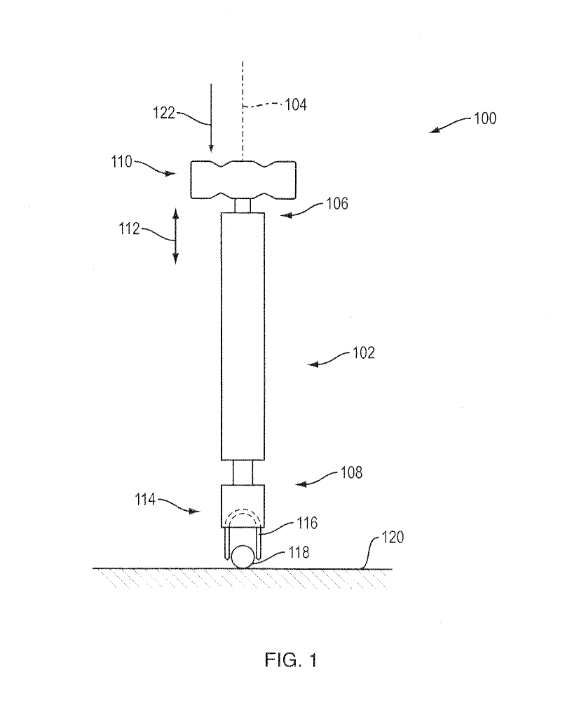

The schematic view shown in FIG. 1 illustrates an exemplary embodiment of a construction apparatus 100 (also “tool 100,” and “hand tool 100”) that is useful to secure fasteners and, in particular, to set electrical staples about electrical wires and conduit carrying the same. The construction apparatus 100 has a handle portion 102 with a longitudinal axis 104 and a first end 106 and a second end 108. At the first end 106, the construction apparatus 100 includes a head portion 110 that the end user can utilize to strike objects. The head portion 110 can translate along the longitudinal axis 104 relative to the handle portion 102, as generally identified by the numeral 112.

On the second end 108, the construction apparatus 100 can include a fastener portion 114 that can receive a fastener 116 thereon. In the present example of FIG. 1, the fastener 116 comprises a staple a crown and legs disposed about an electrical wire 118 that rests on a board 120. Other examples of the fastener 116 can include construction elements (e.g., nails) of varying sizes and characteristics, although as will become apparent from the discussion that follows below, this disclosure contemplates that the construction apparatus 100 is compatible with fasteners having wide applications and variety. In one embodiment, all and/or part of the fastener portion 114 can detach from the second end 108 to allow an end user to interchange with other configurations of the fastener portion 114. The different configurations for the fastener portion 114 can allow the construction apparatus 100 to accommodate different types construction elements, e.g., staples, finish nails, framing nails, and the like. Moreover, the fastener portion 114 (and/or the construction apparatus 100 in general) may utilizes a self-loading mechanism, e.g., a magazine that holds a plurality of fasteners (e.g., the fastener 116) and can locate the plurality of fasteners in position one or more at a time to be driven, as set forth below.

The position of the head portion 110 can vary relative to the handle portion 102, e.g., from a first position spaced apart from the handle portion 102 to a second position proximate the handle portion 102. Operation of the construction apparatus 100 takes advantage of the relative movement of the head portion 110 to affix the fastener 116 into a target or object. For example, changing the position of the head portion 110 can, in turn, impart force onto the fastener 116. In one example, movement of the head portion 110 from the first position to the second position also changes the position of the fastener portion 114 and the fastener 116. In other examples, movement of the head portion 110 from the first position to the second position changes the position of the fastener 116, e.g., the fastener portion 114 does not move relative to the handle portion 102.

In one implementation, the end user can secure a staple onto the fastener portion 114. The end user can then position the staple proximate the target or object. To drive the staple into the board 120, the end user grasps or otherwise stabilizes the handle portion 102 and applies a driving force 122 onto the head portion 110. Examples of the driving force can arise by the end user bring a hand and/or implement (e.g., a hammer) down onto the head portion 110. The driving force 122 causes the head portion 110 to translate (e.g., longitudinal translation 112). As set forth in more detail below, translation of the head portion 112 transmits the driving force 122 to the staple with sufficient magnitude to drive the staple into the board 120. In one example, the top surface of the head portion 110 can include a cushioning element in position to receive the driving force 122. Examples of the cushioning element can comprise material to reduce the impact of the driving force 122 on the hand of the end user.

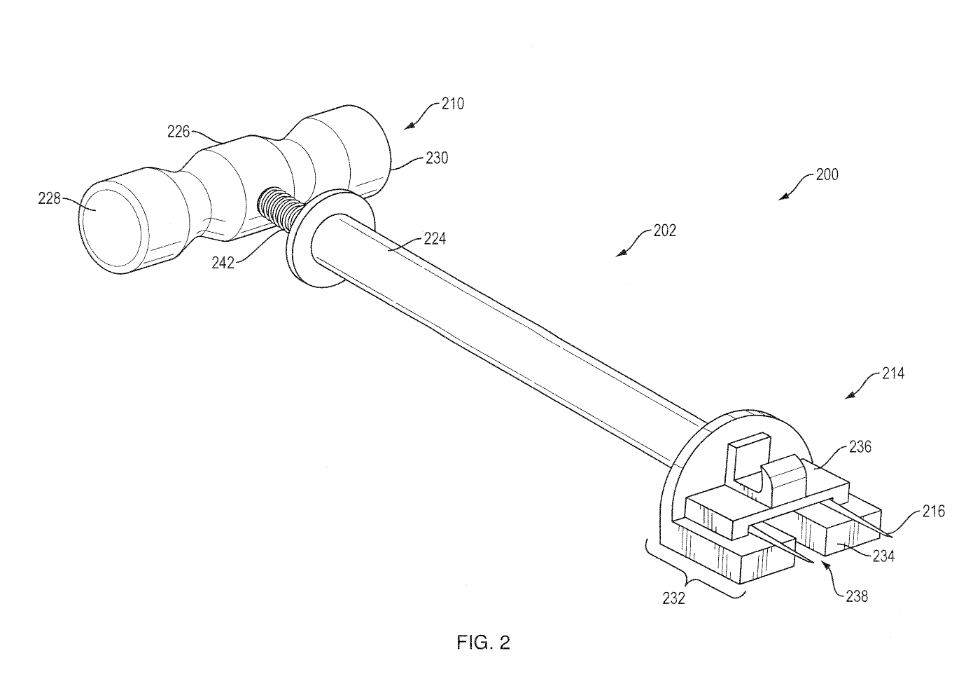

FIG. 2 illustrates a perspective view of an exemplary embodiment of a construction apparatus 200 that an electrician may find useful to drive an electrical staple (e.g., the fastener 216). The handle portion 202 can include a tubular element 224 of generally cylindrical construction. The head portion 210 can include a mallet 226 with one or more striking surfaces (e.g., a first striking surface 228 and a second striking surface 230). The fastener portion 214 can have a fastener guide 232 that orients the fastener 216 in position for the end user to deploy by depressing the mallet 226, as discussed above. In one example, the fastener guide 232 has a base element 234 and a fastener remover element 236. The fastener guide 232 can also include a fastener retention area 238 with a gap and/or opening that can receive, secure, and/or removeably attach the fastener 216 to the construction apparatus 200. Exemplary mechanisms that can secure the electrical staple in the fastener retention area 238, e.g., in the gap, include magnets and/or magnetic components, as well as spring-like members, resilient fingers, and/or other devices that can apply a clamping force onto the fastener 216 when the fastener 216 is in position in the fastener retention area 238.

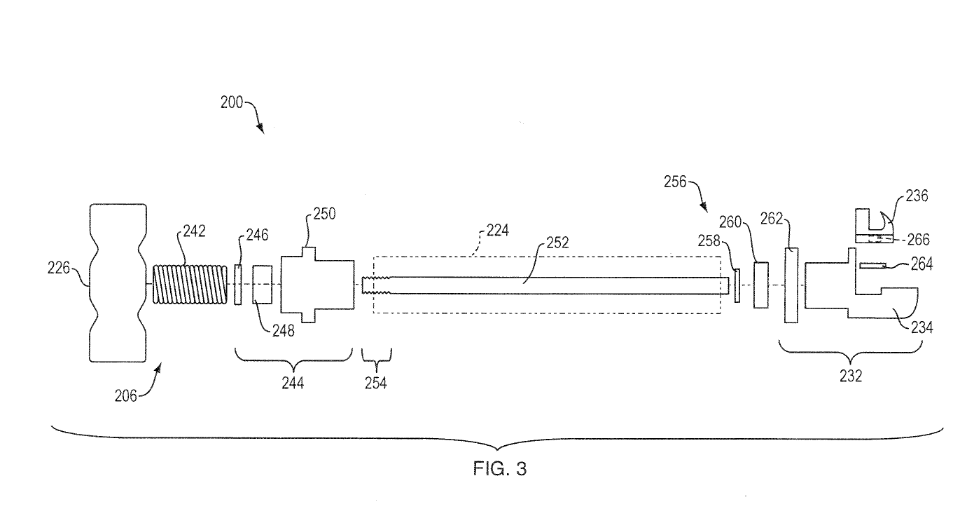

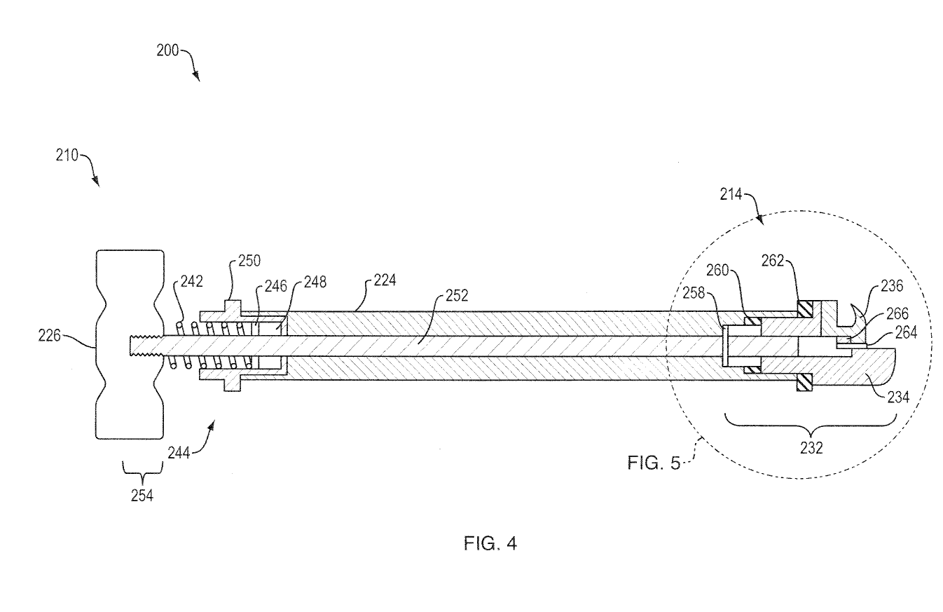

FIGS. 3 and 4 illustrate additional details of the construction apparatus 200. FIG. 3 depicts a side, exploded assembly view of the construction apparatus 200 to illustrate additional details of the construction apparatus 200. Moving from left to right in this diagram, the construction apparatus 200 can include a resilient element 240, shown here in the form of a spring member 242. Examples of the spring member 242 can include coil springs, spring material, and the like. The construction apparatus 200 also has an end cap assembly 244 that mounts to one end of the tubular element 224 proximate the mallet 226. The end cap assembly 244 includes a washer 246, a first bushing 248, and an end cap element 250. The construction apparatus 200 further includes a shaft 252 that has a first threaded section 254 that can engage complimentary threads on the mallet 226. The construction apparatus 200 may also include an anti-rotation element 256, shown here in the form of a pin 258 that penetrates the shaft 252. The construction apparatus 200 also includes a second bushing 260 and a locking element 262, which engages the base component 234. Use of the locking element 262 allows the construction apparatus 200 to vary the depth the fastener (e.g., fastener 216) penetrates into the material via actuation of the mallet 226. In one embodiment, the fastener guide 232 can include one or more standoff elements (e.g., standoff element 264) and a magnet 266. The standoff elements 264 can define the gap and/or opening of the fastener retention area 238 (FIG. 2). Examples of the magnet 266 can incorporate permanent magnet and/or magnetized material that generates a magnetic field. The magnitude of this magnetic field can be sufficient to retain the fastener 216 (FIG. 2) in the fastener retention area 238 (FIG. 2) and, in one construction, the magnetic field retain the fastener when the construction apparatus 200 is held upright, e.g., to position the fastener over an electrical wire as shown in FIG. 1.

FIG. 4 illustrates a side, cross-section view of the construction apparatus 200 in assembled form. In one example, threads on the shaft 252 couple with corresponding threads on the mallet 226. The end cap element 250 inserts into a first end of the tubular member 224. In one example, the spring member 242, the washer 246, and the first bushing 248 can fit into the end cap element 250. This configuration interposes the spring member 242 between the mallet 226 and the washer 246. At the fastener portion 214, the base component 234 and second bushing 260 insert into a second end of the tubular member 224. The locking element 262 secures about the base component 234. The standoff element 264 mounts between the base component 234 and the fastener remover element 236 to create the gap for the fastener retention area 238 (FIG. 3). In one example, the magnet 266 can secure to the fastener remover element 236 in position to effect magnetic field on the gap, thereby securing a fastener therein.

The position of the base component 234 can vary relative to the end of the tubular member 224. This feature permits the construction apparatus 200 to handle fasteners having different sizes and/or characteristics, namely, by changing the depth that the construction tool 200 drives (or, also, “sets”) the fastener into the target object. In one embodiment, the end user can move the base component 234 to a position that corresponds to a desired depth. The end user can then secure the locking element 262, which effectively prevents the base component 234 from moving from its set position. In one example, the locking element 262 has an inner threaded surface that engages complimentary threads on the base component 234. When the locking element 262 tightens against the bottom of the tubular member 224, this inner threaded surface will prevent movement of the base component 234. To change the base component 234 to accommodate for a different desired depth, the locking element 262 is disengaged (e.g., by turning the locking element 262 in a direction that moves the locking element 262 away from the bottom of the tubular member 224), the base component 234 set into its next position, and the locking element 262 is re-engaged (e.g., by turning the locking element 262 in a direction that moves the locking element 262 in contact with the bottom of the tubular member 224).

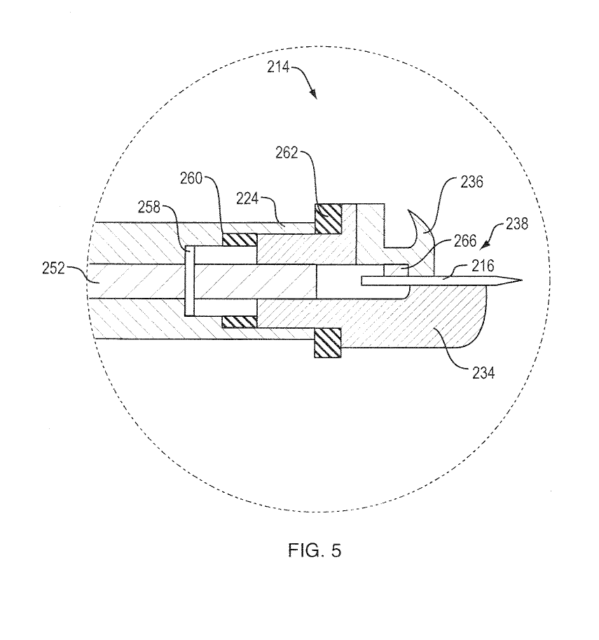

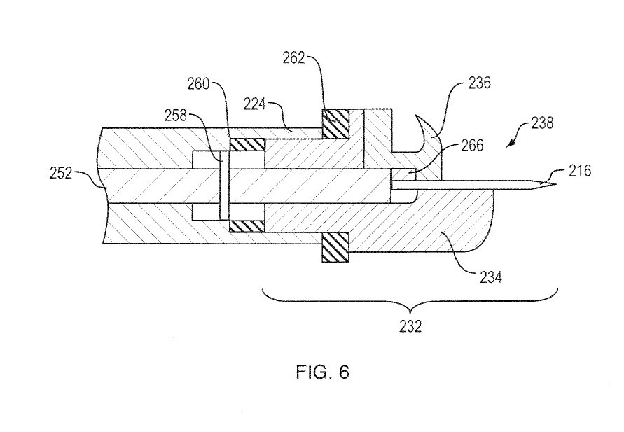

FIGS. 5 and 6 depict the detail view of the construction apparatus 200 in FIG. 4 to illustrate one configuration of the construction apparatus 200 that allows the fastener 216 to move in response to a change of the head portion 210 (FIG. 4) from the first position to the second position. In FIG. 5, the shaft 252 and the fastener 216 are located in an undeployed and/or ready-to-be actuated state. The magnetic field of the magnet 266 secures the fastener 216 in the fastener retention area 238. The spring member 242 (FIG. 4) applies a spring force on the mallet 226 (FIG. 4), thereby maintaining the mallet 226 (FIG. 4) in the first position and positioning the shaft 252 spaced apart from and/or away from the end of the fastener 216.

FIG. 6 shows the shaft 252 and the fastener 216 in a deployed and/or actuated state. As can be seen in FIG. 6, the shaft 252 changes position, e.g., in response to the driving force applied at the head portion 210 (FIG. 4) that causes movement of the mallet 226 (FIG. 4) from the first position to the second position. The movement of the head portion 210 (FIG. 4) moves the shaft 252. In one example, the shaft 252 contacts the fastener 216 with sufficient force to move the fastener 216 from the ready-to-be actuated state to the deployed state. If sufficient driving force is applied, the fastener 216 can penetrate the fastener 216 into the target object in the deployed state. Once the driving force is removed from the head portion 210 (FIG. 4), the spring force of the spring member 242 (FIG. 4) can change the position of the mallet 226 (FIG. 4), e.g., from the second position to the first position. The change in position of the mallet 226 (FIG. 4) will cause the shaft 252 to retract from the deployed state and, in one example, ready the fastener guide 232 to receive another fastener 216 (as shown in FIG. 5).

The remaining discussion below focuses on exemplary configuration for one or more components found, e.g., the construction apparatus 200 of FIGS. 2, 3, 4, 5, and 6. While not necessarily noted, this disclosure contemplates variations in the design of the these components apart from the design illustrated to achieve the functional characteristics and/or qualities of the components as set forth herein. To this end, several factors including material selection, manufacturing techniques, tolerances, and similar considerations may alter the appearance and/or construction of the components. These alterations are, however, not likely to fall outside the scope and spirit of the subject matter that is the focus of this disclosure.

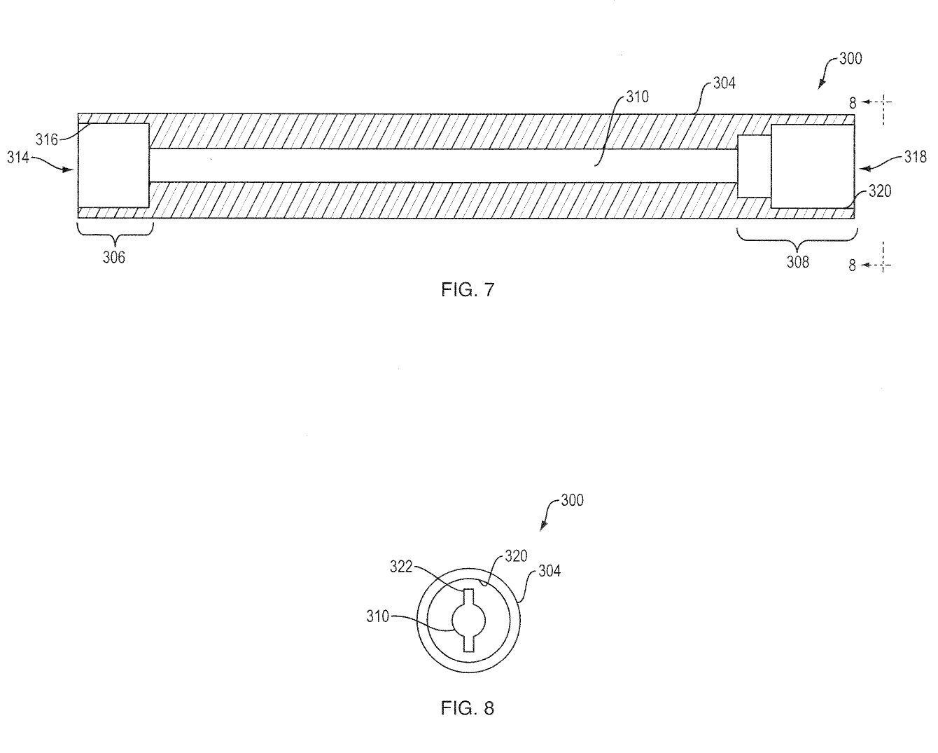

FIGS. 7 and 8 illustrate an example of a tubular member 300 that may find use as the handle of the construction apparatus (e.g., construction apparatus 100 and 200). In FIG. 7, the tubular member 300 has an elongated body 302 with an outer surface 304. The body 302 has one or more receiving areas (e.g., a first receiving area 306 and a second receiving area 308) and a central bore 310 that extends therethrough. The first receiving area 306 has a first receiving bore 314 with a first inner surface 316. The second receiving area 308 can have a second receiving bore 318 with a second inner surface 320. As best shown in FIG. 8, which provides an end view of the tubular member 300, the tubular member 300 can also incorporate an indexing feature 322 at the second receiving area 308. Examples of the indexing feature 322 can include a groove and/or slot that penetrates into the material of the tubular member 300. This groove/slot configuration can receive the pin 258 (FIG. 4) to limit and/or prevent rotation of the shaft 252 (FIG. 4).

The outer surface 304 can have a generally cylindrical shape, as shown, although advantages may also lie in other shapes (e.g., octagon) for purposes of comfort, fit, and ease of use and implementation by the end user. In one embodiment, the outer surface 304 may incorporate various surface textures and coatings, as desired. The bores (e.g., the first receiving bore 314 and the second receiving bore 318) can be sized and configured to receive, respectively, the end cap element 250 (FIG. 4) and the base element 234 (FIG. 4) and second bushing 260 (FIG. 4). In one example, the bore surfaces (e.g., the first inner surface 316 and the second inner surface 320) are threaded to releaseably engage the components inserted therein. In other examples, however, the bores 314, 318 may have dimensions that result in various fits (e.g., interference, press, friction) with the elements that form parts of the assembly discussed herein.

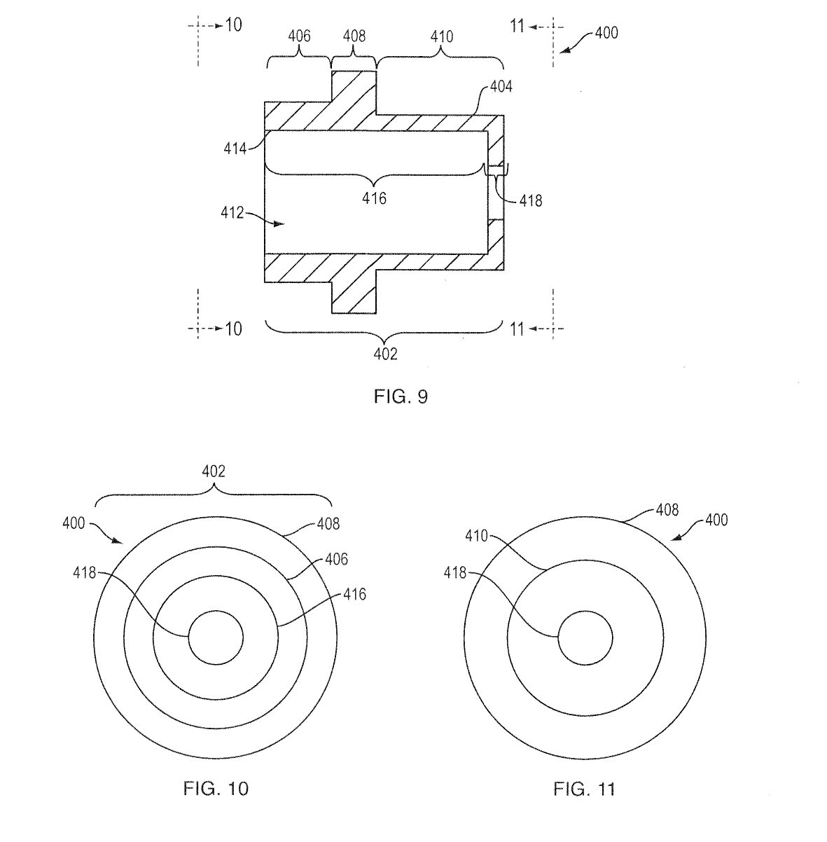

FIGS. 9, 10, and 11 depict an example of an end cap element 400 that can insert, e.g., into the tubular member 300 FIGS. 7 and 8. The end cap element 400 has an end cap body 402 with a stepped outer surface 404 that forms a number of outer sections (e.g., a first outer section 406, a second outer section 408, and a third outer section 410). The end cap body 402 also has a central bore formation 412 with a stepped inner surface 414, which forms a number of inner sections (e.g., a first inner section 416 and a second inner section 418).

One or more of the outer section 406, 408, 410 can be curved and/or curvilinear, thus forming the circular outer boundary (as shown in FIGS. 10 and 11). This disclosure contemplates other shapes, however, which may afford the end cap element 400 with additional advantages and benefits. For example, the outer section 408 may incorporate flats that allow for effective mating with a wrench and/or other tools to assemble and disassemble the end cap 400 to the tubular member 300 (FIGS. 7 and 8).

The central bore formation 412 affords the construction apparatus with compact assembly. The first inner section 416, for example, has dimensions to receive at least a portion of the spring member 242 (FIG. 4) as well as the washer 244 (FIG. 4) and the first bushing (FIG. 4). This assembly provides effective compression of the spring member 242 to generate the spring force that moves the mallet 226 (FIG. 4) from the second position to the first position. On the other hand, the second inner section 418 can be sized to support the shaft 252 (FIG. 4) but to allow translation of the shaft 252 (FIG. 4) as disclosed herein.

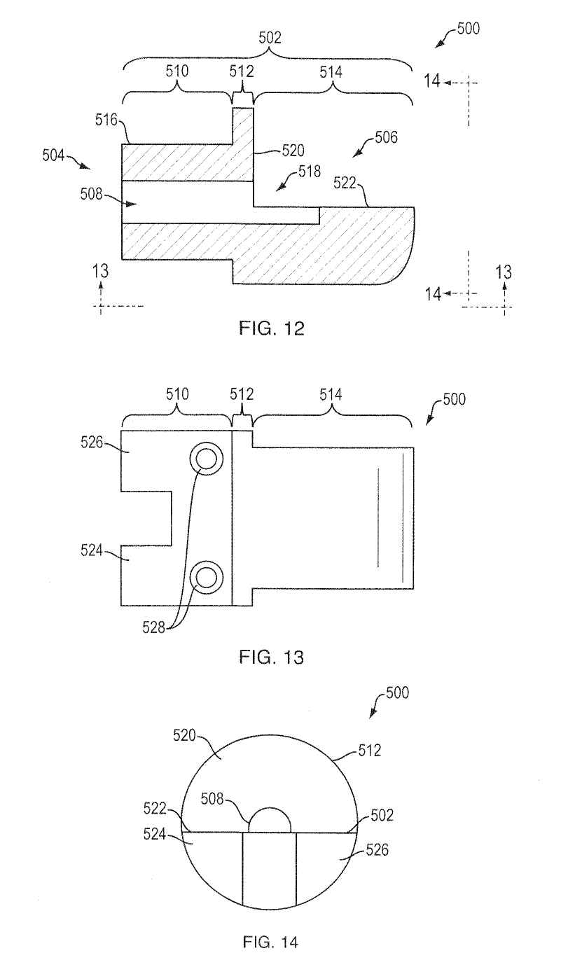

FIGS. 12, 13, and 14 depict an example of a base component 500. The base component 500 comprises a base body 502 that has a first end 504, a second end 506, and a central base bore 508. Examples of the central base bore 508 can receive and support the shaft 252 (FIG. 4). The base body 502 forms a first base section 510, a second base section 512, and a shoulder section 514 disposed therebetween. Examples of the base body 502 can incorporate threads along the first base section 510. These threads can be complimentary to threads found in the receiving area 308 (FIG. 7) of the tubular member 310 (FIG. 7). The shoulder section 514 can incorporate flats and/or surface texture (e.g., knurling) that facilitate engagement of the threads.

As also in FIG. 12, the first base section 510 has an outer base surface 516 that extends from the first end 504 to the shoulder section 514. In the second base section 512, the base body 502 forms a remover receiving area 518 forming a wall member 520 and a mounting member 522. In one implementation, the mounting member 522 supports the fastener before and/or during and/or after deployment of the fastener as contemplated herein. As best shown in FIG. 13, the base body 502 can have one or more supporting members (e.g., a first supporting member 524 and a second supporting member 526). The base body 502 can also include one or more mounting features 528, which in the present example comprise counter-bore openings that penetrate through the base body 502 to the remove receiving area 518 (FIG. 12).

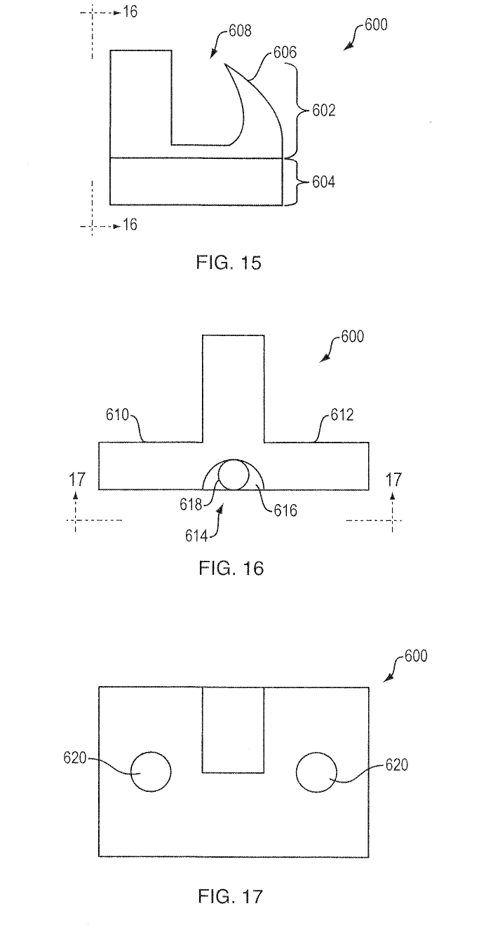

FIGS. 15, 16, and 17 depict an example of a fastener remover component 600. The fastener remover component 600 includes a remover portion 602 and a mounting portion 604. The remover portion 602 has a first remover member 606 and a remover opening 608. As best shown in FIG. 16, the mounting portion 604 can form one or more mounting flanges (e.g., a first mounting flange 610 and a second mounting flange 612). The remover component 600 also has a groove 614 with a back wall 616 that has a remover bore 618 disposed therein. In one example, the groove 614 can have dimensions to receive the shaft (e.g., shaft 252 of FIG. 4) during deployment of the fastener. The remover bore 618 can receive and secure the magnet (e.g., magnet 266 of FIG. 4) in position to allow the magnetic field to dissipate into the fastener receiver area (e.g., fastener receiver area 238 of FIG. 2). In FIG. 17, the remover component 600 is shown to also include one or more remover mounting features 620.

Examples of the remover portion 602 can interface with fasteners, e.g., staples, to allow the end user to extract the fastener, e.g., from a board (e.g., board 120 of FIG. 1). In one implementation, the remover portion 602 can be positioned to allow the crown of the staple into the remover opening 608. Pivoting the construction apparatus, e.g., by way of an applied removal force, engages the crown with the first remover member 608, thereby causing the staple to lift upwards and out of the board. As shown in the figures, the first remover member 608 can have a generally curvilinear end portion that terminates at an edge proximate the remover opening 608. This edge can help prevent the crown of the staple from disengaging from the remover portion 602 as force is applied, e.g., by the construction apparatus. In some examples, surfaces in the remover opening 608 may have surface texture (e.g., grooves, divots, etc.) that can receive at least a portion of the crown of the staple to further promote effective engagement of the crown by the remover portion 602.

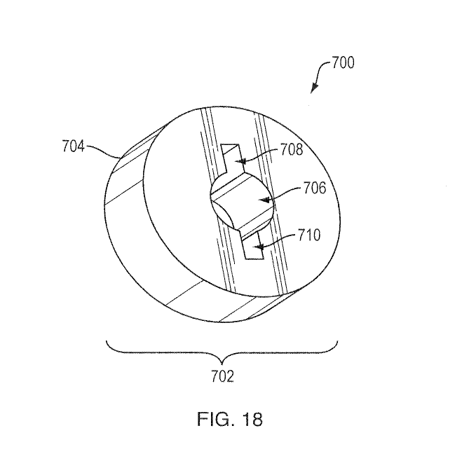

FIG. 18 depicts a perspective view of an example of a bushing 700. The bushing 700 has a bushing body 702 with an outer bushing surface 704 and an inner bushing bore 706. Generally, dimensions of the outer bushing surface 704 permit the bushing 700 to insert into the receiving area 308 (FIG. 7) of the tubular member 310 (FIG. 7). The bushing bore 706 helps to support and guide the shaft 252 (FIG. 4) during actuation. In one example, the bushing body 702 also includes an indexing feature in the form of slots (e.g., a first slot 708 and a second slot 710) that extend axially through the bushing body 702. The slots 708, 710 also extend radially away from the inner bushing bore 704. The indexing feature can prevent rotation of the shaft 252, particularly when the fastener guide 232 (FIG. 4) is spaced apart from the tubular member 224 (FIG. 4) to accommodate fasteners of particular dimensions.

Various materials are contemplated for use in the components found in embodiments of the construction apparatus (e.g., construction apparatus 100 and 200). Suitable materials can include any variety of metals, plastics, and composites, as well as combinations thereof. One or more materials may be selected based on factors such as cost and production considerations, and thus the materials used may be more or less suited for certain machining and manufacturing operations (e.g., molding, machining, turning, casting, drilling, etc.) Moreover, certain other factors such as materials properties (e.g., tensile and compressive strength, hardness, etc.) may be considered in view of the operational characteristics of the construction apparatus (e.g., the construction apparatus 100 and 200). For example, materials must be strong enough to withstand forces consistent with those of hammering and striking objects, but light enough to provide a product with adequate weight and balance for its required implementation in the trade.

Where applicable, one or more of the elements, assemblies, and parts can be constructed monolithically, as single, unitary components. Such components may be selected to enable higher production yields at lower costs. On the other hand, other parts of the construction apparatus 100, 200 may comprise one or more pieces, which may or may not be shown and described herein. These pieces can be assembled using known fabrication techniques and fasteners, e.g., consistent with the assembly of construction and trade tools.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A construction apparatus, comprising:
a handle portion having a first end and a second end;
a head portion coupled to the first end, the head portion having a first position and a second position relative to the handle portion; and
a fastener portion coupled to the second end, the fastener portion comprising a fastener retention area that can orient a fastener in a ready-to-actuate state,
wherein changing the head portion from the first position to the second position moves the fastener from the ready-to-actuate state to a deployed state.

2. The construction apparatus of claim 1, wherein the fastener portion comprises a magnet that generates a magnetic field in the fastener retention area.

3. The construction apparatus of claim 1, further comprising a spring member that generates a spring force to move the head portion from the second position to the first position.

4. The construction apparatus of claim 1, further comprising a shaft coupled with the head portion, the shaft extending through the handle portion and terminating at an end proximate the fastener portion.

5. The construction apparatus of claim 4, wherein the end of the shaft moves in response to movement of the head portion between the first position and the second position, and wherein movement of the end of the shaft causes the fastener to move to the deployed state.

6. The construction apparatus of claim 5, wherein the end of the shaft contacts the fastener.

7. The construction apparatus of claim 4, further comprising an anti-rotation element that prevents rotation of the head portion.

8. The construction apparatus of claim 7, wherein the anti-rotation element engages the shaft and the handle portion.

9. The construction apparatus of claim 1, wherein the fastener portion comprises a fastener remover element that engages the fastener to transfer a removal force applied on said construction apparatus to the fastener.

10. The construction apparatus of claim 8, wherein the fastener remover element has a remover opening and a remover portion, wherein the remover opening can receive a crown of a staple, and wherein the remover portion engages the crown in response to the removal force.

11. A tool, comprising:
a tubular member having a first end, a second end, and a central bore extending from the first end to the second end;
a shaft disposed in the central bore;
a mallet coupled to the shaft proximate the first end, the mallet having a first position and a second position relative to the tubular member; and
a fastener guide disposed on the second end of the tubular member, the fastener guide having a fastener retention area that can receive an end of the shaft, the fastener retention area orienting a fastener in a ready-to-actuate state.

12. The tool of claim 11, further comprising a spring member disposed about the shaft proximate the first end of the tubular member.

13. The tool of claim 12, further comprising a end cap assembly disposed on the first end of the tubular member, the end cap assembly comprising an end cap element with an end cap bore that receives at least a portion of the spring member.

14. The tool of claim 11, further comprising a pin disposed in the shaft, wherein the pin resides in a slot that extends radially away from the central bore proximate the second end of the tubular member.

15. The tool of claim 11, wherein the end of the shaft moves in response to movement of the mallet between the first position and the second position, and wherein movement of the end of the shaft causes the fastener to move from the ready-to-be actuated state to a deployed state.

16. The tool of claim 11, further comprising a remover element disposed on the fastener guide, wherein the remover element is configured to transfer a removal force to a portion of the fastener.

17. A tool for deploying a staple, said tool comprising:
a fastener guide having a base element and a fastener remover element coupled to the base element to form a gap to receive the staple and orient the staple in a ready-to-actuate state, the fastener remover element comprising a remover opening and a remover portion, wherein the remover opening is configured to receive a portion of the staple to position the remover portion to engage the portion of the staple in response to a removal force applied on said tool.

18. The device of claim 17, further comprising a magnet disposed on the fastener guide to generate a magnetic field in the gap.

19. The device of claim 17, further comprising a locking element disposed about a section of the base component, the locking element engaging a portion of said tool to prevent movement of the fastener guide.

20. The device of claim 19, wherein the locking element comprises threads that engage corresponding threads on the base component.
